(19) United States
(12) Patent Application Publication
(10) Pub. No.: US 2023/0079944 A1
(43) Pub. Date: Mar. 16, 2023

(54) METHODS AND COMPOSITIONS FOR THE DETOXIFICATION OF COFFEE THROUGH PREPARATION WITH THERMALLY ACTIVATED MINERAL COMPLEXES

(71) Applicant: BeProof, Inc., Kent, WA (US)

(72) Inventors: Ian Mitchell, Bartlesville, OK (US); David Asprey, Cobble Hill, CA (US)

(21) Appl. No.: 17/932,090

(22) Filed: Sep. 14, 2022

Related U.S. Application Data
(60) Provisional application No. 63/261,193, filed on Sep. 14, 2021.

(51) Int. Cl. A23F 5/14; A23F 5/26

(52) U.S. Cl. CPC A23F 5/145; A23F 5/26

(57) ABSTRACT

Provided herein are methods for production of coffee intended to use a humic and or fulvic mineral blend in a thermally activated state for the enhanced detoxification of mycotoxins, other toxic and biologically detrimental compounds via their inclusion in a coffee beverage prior to and during the brewing process that additionally remineralizes the body via consumption. The nutritional compositions include humic and/or fulvic mineral blends and derivatives thereof delivered via coffee beans, grounds, capsules, bags, ampules, syringes, or K-Cups. Upon brewing, the mineral blends are solubilized and delivered into the aqueous base of the coffee and are ready for consumption.

### INCORPORATION BY REFERENCE TO ANY PRIORITY APPLICATIONS

This application claims benefit of U.S. Provisional Pat. Application No. 63/261193, filed Sep. 14, 2021, and titled “METHODS AND COMPOSITIONS FOR THE DETOXIFICATION OF COFFEE THROUGH PREPARATION WITH THERMALLY ACTIVATED MINERAL COMPLEXES.” The entire disclosure of the above item is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57.

### BACKGROUND

### Field

The present disclosure relates generally to consumable nutritional compositions and more particularly to aqueous nutritional compositions containing humic and/or fulvic mineral blends and derivatives thereof.

### Description of Related Art

Beverages such as coffee and tea are typically contaminated with mycotoxins and other detrimental compounds. Additionally, they are poor sources of minerals, and many people are presently at a nutritional deficit regarding the amount of balanced minerals in their bodies and hence experience decreased biological functioning.

### SUMMARY

Embodiment of the present disclosure relate to compositions of consumable nutritional compositions and aqueous nutritional compositions containing humic and/or fulvic mineral blends and derivatives thereof and methods for producing consumable nutritional compositions and aqueous nutritional compositions containing humic and/or fulvic mineral blends and derivatives thereof.

According to one embodiment, a composition can comprise (i) a humic mineral blend and/or fulvic mineral blend, and (ii) ground coffee beans, wherein the composition is configured to provide detoxification of mycotoxins and other toxic and biologically detrimental compounds via the inclusion of the humic mineral blend and/or fulvic mineral blend in a coffee beverage prior to and during a brewing process thereby fortifying the coffee beverage; and wherein the composition forms a dispersion upon brewing and is thermally enhanced.

The composition of the preceding paragraph or in other embodiments can include one or more of the following features. The composition can comprise 0.01% to 10.00% by weight of the humic mineral blend and/or fulvic mineral blend to 90.00% to 99.99% by weight of the ground coffee beans. The composition can be a powdered composition. A beverage made by brewing the composition. The beverage can further comprise an additive. The additive can be a sweetener, a stabilizer, a flavoring agent, an SCT, an MCT, an LCT or any combination thereof. The beverage can be included in a sealed container.

According to one embodiment, a coffee-based beverage can comprise a humic mineral blend and/or fulvic mineral blend.

The coffee-based beverage of the preceding paragraph or in other embodiments can include one or more of the following features. The humic mineral blend and/or fulvic mineral blend can provide detoxification of mycotoxins and other toxic and biologically detrimental compounds by the inclusion of the humic mineral blend and/or fulvic mineral blend in the coffee-based beverage prior to and during the brewing process thereby fortifying the coffee-based beverage. The coffee-based beverage can comprise 0.01% to 10.00% by weight of the humic mineral blend and/or fulvic mineral blend. The coffee-based beverage can further comprise an additive. The additive can be a sweetener, a stabilizer, a flavoring agent, or a combination thereof. The beverage can be included in a sealed container.

According to one embodiment, a coffee bean can comprise a coating containing a humic mineral blend and/or fulvic mineral blend.

The coffee bean of the preceding paragraph or in other embodiments can include one or more of the following features. The coffee bean coated with the humic mineral blend and/or fulvic mineral blend can be configured to be ground and brewed and provides detoxification of mycotoxins and other toxic and biologically detrimental compounds by the inclusion of the humic mineral blend and/or fulvic mineral blend coating prior to the grinding and brewing process. The coffee bean can comprise 0.01% to 10.00% by weight of the humic mineral blend and/or fulvic mineral blend to 90.00% to 99.99% by weight of the coffee bean. The humic mineral blend and/or fulvic mineral blend can be at least 95% pure. The coating is lower in heavy metals, insecticides, and/or mycotoxins.

According to one embodiment, a composition can comprise (i) coffee grounds and (ii) a humic mineral blend and/or fulvic mineral blend.

The composition of the preceding paragraph or in other embodiments can include one or more of the following features. The composition can be configured to provide detoxification of mycotoxins and other toxic and biologically detrimental compounds via the inclusion of the humic mineral blend and/or fulvic mineral blend in the composition prior to and during a brewing process. The composition can comprise 0.01% to 10.00% by weight of the humic mineral blend and/or fulvic mineral blend to 90.00% to 99.99% by weight of the coffee grounds.

According to one embodiment, a method of preparing a beverage, the method can comprise providing a composition comprising (i) a humic mineral blend and/or fulvic mineral blend and (ii) ground coffee beans, and brewing the composition by subjecting the composition to liquid at a temperature above room temperature and passing the liquid through a filter; wherein the composition forms a dispersion upon brewing and is thermally enhance; and wherein the composition provides detoxification of mycotoxins and other toxic and biologically detrimental compounds via the inclusion of the humic mineral blend and/or fulvic mineral blend in the composition prior to and during the brewing of the composition thereby fortifying the beverage.

The method of the preceding paragraph or in other embodiments can include one or more of the following features. The composition can comprise 0.01% to 10.00% by weight of the humic mineral blend and/or fulvic mineral blend to 90.00% to 99.99% by weight of the ground coffee beans. The temperature can be between 125° F. to 185° F.

Other objects, features and advantages of the present invention will become apparent from the following detailed description. It should be understood, however, that the detailed description and the specific examples, while indicating embodiments of the invention, are given by way of illustration only, since various changes and modifications within the spirit and scope of the invention will become apparent to those skilled in the art from this detailed description.

Any of the features, components, or details of any of the arrangements or embodiments disclosed in this application, including without limitation any of the compositions and methods disclosed below, are interchangeably combinable with any other features, components, or details of any of the arrangements or embodiments disclosed herein to form new arrangements or embodiments.

### DETAILED DESCRIPTION

The present disclosure relates generally to consumable nutritional compositions and more particularly to aqueous nutritional compositions containing humic and/or fulvic mineral blends and derivatives thereof. In some cases, the nutritional compositions containing humic and/or fulvic mineral blends and derivatives thereof can be utilized in a thermally activated state for detoxification of mycotoxins, other toxic and biologically detrimental compounds via their inclusion in a coffee beverage prior to and during the brewing process. The thermal activation of the included mineral blends can allow for enhanced detoxification and as described herein can be a method whereby the mineral blends are solubilized in the composition during brewing to achieve this end.

Provided herein are compositions and methods for detoxifying a coffee beverage via fortification with specific mineral complexes in a thermally active state as they show a heightened binding coefficient to both endogenous and exogenous toxins. By way of example to illustrate various aspects of the disclosed concepts, several exemplary embodiments of compositions and methods are provided herein.

In some cases, a nutritional composition can be used for detoxifying a coffee beverage during the brew cycle and leaving the subsequent beverage less detrimental for those consuming it as well as enhanced by virtue of the inclusion of humic and fulvic mineral complexes. The composition can include a humic and/or fulvic mineral blend and combinations thereof. In some cases, the composition can be a powdered composition. The composition can include dehydrated, lyophilized, or ground powder compositions or any other powdered compositions.

In some cases, the powdered nutritional composition can form a coating on coffee beans. After subsequent grinding and brewing of the nutritional composition with the coffee grounds (or ground coffee beans), the dispersion can be solubilized and mixed into the hot beverage and binds to toxins with a higher degree of efficiency due to the thermal activation during the brew cycle. In some aspects, the powdered nutritional composition comprises 0.01% to 10.00% by weight of the humic and/or fulvic mineral blend to 90.00% to 99.99% by weight of the coffee beans. In some aspects, the composition comprises at least about 0.01%, 0.05%, 0.10%, 0.15%, 0.2%, 0.25%, 0.3%, 0.4%, 0.5%, 0.6%, 0.7%, 0.8%, 0.9%, 1.0%, 1.2%, 1.4%, 1.6%, 1.8%, 2.0%, 2.2%, 2.4%, 2.6%, 2.8%, 3.0%, 3.5%, 4.0%, 4.5%, 5.0%, 5.5%, 6.0%, 6.5%, 7.0%, 7.5%, 8.0%, 8.5%, 9.0%, or 9.5% humic and/or fulvic mineral blend. In some aspects, the composition comprises at most about 10.00%, 9.5%, 9.0%, 8.5%, 8.0%, 7.5%, 7.0%, 6.5%, 6.0%, 5.5%, 5.0%, 4.5%, 4.0%, 3.5%, 3.0%, 2.8%, 2.6%, 2.4%, 2.2%, 2.0%, 1.8%, 1.6%, 1.4%, 1.2%, 1.0%, or 0.5% humic and/or fulvic mineral blend.

In some cases, a composition can be used for detoxifying a coffee beverage during the brew cycle and leaving the subsequent beverage less detrimental for those consuming it as well as enhanced by virtue of the inclusion of humic and fulvic mineral complexes. The humic and/or fulvic mineral blend and combinations thereof can be mixed into the coffee grounds prior to brewing. In some cases, the composition can bind to toxins within a higher degree of efficiency due to the thermal activation during the brew cycle. In some aspects, the powdered nutritional composition comprises 0.01% to 10.00% by weight of the humic and/or fulvic mineral blend to 90.00% to 99.99% by weight of the coffee grounds. In some aspects, the composition comprises at least about 0.01%, 0.05%, 0.10%, 0.15%, 0.2%, 0.25%, 0.3%, 0.4%, 0.5%, 0.6%, 0.7%, 0.8%, 0.9%, 1.0%, 1.2%, 1.4%, 1.6%, 1.8%, 2.0%, 2.2%, 2.4%, 2.6%, 2.8%, 3.0%, 3.5%, 4.0%, 4.5%, 5.0%, 5.5%, 6.0%, 6.5%, 7.0%, 7.5%, 8.0%, 8.5%, 9.0%, or 9.5% humic and/or fulvic mineral blend. In some aspects, the composition comprises at most about 10.00%, 9.5%, 9.0%, 8.5%, 8.0%, 7.5%, 7.0%, 6.5%, 6.0%, 5.5%, 5.0%, 4.5%, 4.0%, 3.5%, 3.0%, 2.8%, 2.6%, 2.4%, 2.2%, 2.0%, 1.8%, 1.6%, 1.4%, 1.2%, 1.0%, or 0.5% humic and/or fulvic mineral blend.

In some cases, the nutritional composition can be used for detoxification of mycotoxins, other toxic and biologically detrimental compounds via their inclusion in a coffee beverage prior to and during the brewing process thereby fortifying a coffee beverage. The composition can include a humic mineral blend and/or fulvic mineral blend, and ground coffee beans. The composition can form a dispersion upon brewing and is thermally enhanced.

In some cases, a coffee beverage can be made by brewing the composition with the humic mineral blend and/or fulvic mineral blend and ground coffee beans. In other cases, composition with the humic mineral blend and/or fulvic mineral blend can form a coating on coffee beans and the coffee beans with the humic mineral blend and/or fulvic mineral blend coating can be ground and brewed to form the coffee beverage. In some cases, the humic mineral blend and/or fulvic mineral blend is at least 95% pure. In some cases, the coffee beans can include a coating that can be lower in heavy metals, insecticides, and mycotoxins.

An additive can be added to the composition prior to brewing or after brewing. The additive can include one or more of a sweetener, a stabilizer, a flavoring agent, an SCT (short -chain triglycerides), an MCT (medium-chain triglycerides), an LCT (long-chain triglycerides) or any combination thereof.

The composition can be contained in a sealed container prior to use.

Provided herein are compositions for and methods for production of coffee intended to use a humic and or fulvic mineral blend in a thermally activated state for the enhanced detoxification of mycotoxins, other toxic and biologically detrimental compounds via their inclusion in a coffee beverage prior to and during the brewing process that additionally remineralizes the body via consumption. The nutritional compositions include humic and/or fulvic mineral blends and derivatives thereof delivered via coffee beans, grounds, capsules, bags, ampules, syringes, or K-Cups. Upon brewing, the mineral blends are solubilized and delivered into the aqueous base of the coffee and are ready for consumption.

The term “nutritional composition” as used herein can refer to nutritional liquids and nutritional powders (i.e., “powdered nutritional compositions”), the latter of which may be reconstituted to form a nutritional liquid, all of which are suitable for oral consumption by a human. Although not a requirement, such nutritional compositions can comprise at least one mineral blend.

The terms “coffee beverage” and “coffee-based beverage,” as used herein can refer to a beverage that is served or consumed above room temperature or above 32° F. A coffee beverage can be served or consumed between a temperature of 32° F. to 212° F., including a temperature between 125° F. to 185° F.

The term “minerals” as used herein can refer to any minerals or mineral compositions or blends. For example, the term “minerals” can refer to any one of humic mineral blends and/or fulvic mineral blends.

The term “humic mineral blend” as used herein, unless otherwise specified, refers to one or more of humic acid or related structures as described or otherwise suggested herein. Humic sources suitable for use in the powdered nutritional composition of the present disclosure include free humic acid as well as complexes containing various esters, salts, or other derivatives or related structures thereof, including those that conform to the general structure of humic acid as shown by this formula:

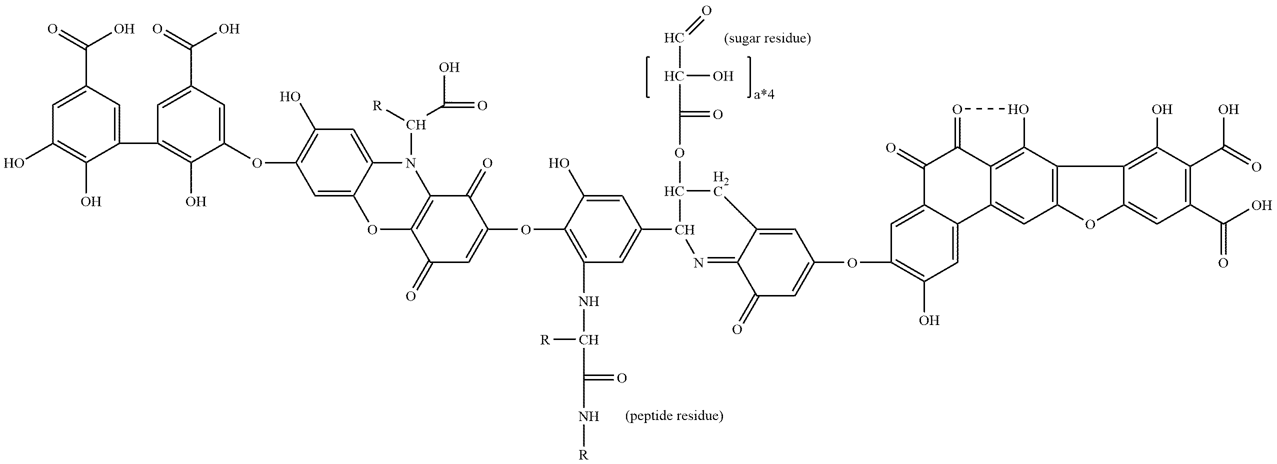

Humic acid is not a single acid; rather, it is a complex mixture of many different acids containing carboxyl and phenolate groups so that the mixture behaves functionally as a dibasic acid or, occasionally, as a tribasic acid. The average molecular weight of the humic acids is believed to be between 5,000 and 50,000. They have no definite x-ray or electron diffraction and are presumed to be amorphous.

The term “fulvic mineral blend” as used herein, unless otherwise specified, refers to one or more of fulvic acid or related structures as described or otherwise suggested herein. Fulvic sources suitable for use in the powdered nutritional composition of the present disclosure include free fulvic acid as well as complexes containing various esters, salts, or other derivatives or related structures thereof, including those that conform to the general structure of fulvic acid as shown by this formula:

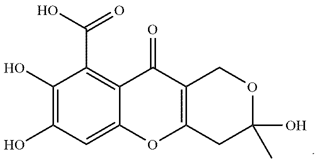

Fulvic acid is not a single acid but consists of a number of organic acids which have been classified by scientists into one group having similar physical and chemical characteristics. Although the term “fulvic acid” is commonly used in the field and in the literature, the term actually embraces the plural instead of the singular; i.e., fulvic acids is the most technically correct, but fulvic acid is the generally accepted norm. According to certain embodiments of the present invention, the fulvic acid may be purified or substantially purified before incorporation into a composition for human consumption.

A sweetener as used herein may be any a nutritive sweetener or a non-nutritive sweetener. Examples of sweeteners include fructose (fruit sugar), sucrose (table sugar), dextrose, levulose, lactose (milk sugar), invert sugar, molasses, brown sugar, honey, maltose, stevia, monk fruit, D-allulose, acesulfame potassium, sucralose, erythritol, xylitol, sorbitol, mannitol, maltitol, isomalt, lycasin, lactitol, aspartame, saccharin, cyclamate, neotame, and advantame.

The term “stabilizer,” as used herein can refer to an additive that helps maintain emulsions, add viscosity, and/or prevent degeneration in beverages. Examples of stabilizers include hydrocolloids (such as xanthan, gum arabic and gum acacia), modified starches, pectin, carrageenan, casein and inulin.

The term “flavoring agent,” as used herein can refer to agents that complement, magnify, or modify the taste and aroma of beverages. A flavoring agent may be a natural or artificial flavoring. Examples of flavoring agents include cocoa, chai, vanilla, coconut, and hazelnut flavoring.

As used herein, “essentially free,” in terms of a specified component, is used herein to mean that none of the specified component has been purposefully formulated into a composition and/or is present only as a contaminant or in trace amounts. The total amount of the specified component resulting from any unintended contamination of a composition is therefore well below 0.05%, preferably below 0.01%. In some case, no amount of the specified component can be detected with standard analytical methods.

Throughout this application, the terms “brewing,” “brewed,” and/or “brew cycle” are used to indicate the period during which the coffee beans and/or grounds that have been pretreated with the humic and/or fulvic mineral blend are exposed to an enhanced thermal load by virtue of their exposure to heated water. The heated water can be prepared and served or consumed between a temperature of 32° F. to 212° F., including a temperature between 125° F. to 185 °.

As used herein the specification, “a” or “an” may mean one or more. As used herein in the claim(s), when used in conjunction with the word “comprising,” the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the inherent variation in the method being employed to determine the value, the variation that exists among the study subjects, or a value that is within 10% of a stated value.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the principles and features disclosed herein. Certain embodiments of the disclosure are encompassed in the claim set listed below or presented in the future.

1. A composition comprising:
(i) a humic mineral blend and/or fulvic mineral blend, and
(ii) ground coffee beans,
wherein the composition is configured to provide detoxification of mycotoxins and other toxic and biologically detrimental compounds via the inclusion of the humic mineral blend and/or fulvic mineral blend in a coffee beverage prior to and during a brewing process thereby fortifying the coffee beverage; and
wherein the composition forms a dispersion upon brewing and is thermally enhanced.

2. The composition of claim 1, comprising 0.01% to 10.00% by weight of the humic mineral blend and/or fulvic mineral blend to 90.00% to 99.99% by weight of the ground coffee beans.

3. The composition of claim 1, wherein the composition is a powdered composition.

4. A beverage made by brewing the composition of claim 1.

5. The beverage of claim 4, further comprising an additive.

6. The beverage of claim 5, wherein the additive is a sweetener, a stabilizer, a flavoring agent, an SCT, an MCT, an LCT or any combination thereof.

7. The beverage of claim 4, comprised in a sealed container.

8-13. (canceled)

14. A coffee bean comprising a coating containing a humic mineral blend and/or fulvic mineral blend.

15. The coffee bean of claim 14, wherein the coffee bean coated with the humic mineral blend and/or fulvic mineral blend is configured to be ground and brewed and provides detoxification of mycotoxins and other toxic and biologically detrimental compounds by the inclusion of the humic mineral blend and/or fulvic mineral blend coating prior to the grinding and brewing process.

16. The coffee bean of claim 14, comprising 0.01% to 10.00% by weight of the humic mineral blend and/or fulvic mineral blend to 90.00% to 99.99% by weight of the coffee bean.

17. The coffee bean of claim 14, wherein the humic mineral blend and/or fulvic mineral blend is at least 95% pure.

18. The coffee bean of claim 14, wherein the coating is lower in heavy metals, insecticides, and/or mycotoxins.

19-21. (canceled)

22. A method of preparing a beverage, the method comprising:
providing a composition comprising (i) a humic mineral blend and/or fulvic mineral blend and (ii) ground coffee beans; and
brewing the composition by subjecting the composition to liquid at a temperature above room temperature and passing the liquid through a filter;
wherein the composition forms a dispersion upon brewing and is thermally enhanced;and
wherein the composition provides detoxification of mycotoxins and other toxic and biologically detrimental compounds via the inclusion of the humic mineral blend and/or fulvic mineral blend in the composition prior to and during the brewing of the composition thereby fortifying the beverage.

23. The method of claim 22, wherein the composition comprises 0.01% to 10.00% by weight of the humic mineral blend and/or fulvic mineral blend to 90.00% to 99.99% by weight of the ground coffee beans.

24. The method of claim 22, wherein the temperature is between 125° F. to 185° F.
